(19) United States
(12) Patent Application Publication
(10) Pub. No.: US 2026/0091463 A1
(43) Pub. Date: Apr. 2, 2026

(54) PAD FOR CHEMICAL MECHANICAL POLISHING

(71) Applicant: DuPont Electronic Materials Holding, Inc., Newark, DE (US)

(72) Inventors: Matthew R. Gadinski, Oxford, PA (US); Annette M. Crevasse, Elkton, MD (US)

(21) Appl. No.: 18/900,397

(22) Filed: Sep. 27, 2024

(51) Int. Cl. B24B 37/24; C08G 18/12; C08J 9/232

(52) U.S. Cl. CPC B24B 37/24; C08G 18/12; C08J 9/232; C08J 2203/22; C08J 2375/08

(57) ABSTRACT

A polishing pad suitable for polishing at least one of semiconductor, optical, magnetic or electromechanical substrates comprises: a polishing layer including a polyurethane wherein the polyurethane has phase separated silicon-rich domains surrounded by polyurethane regions wherein the phase separated silicon-rich domains comprise silicone-based oligomeric repeat units that are covalently bonded to the polyurethane. Polishing using this pad can achieve higher removal rate and/or lower defect than when polishing with a pad which is similar but which lacks the phase separated silicon-rich domains.

### FIELD OF THE INVENTION

The field of this invention is chemical mechanical polishing and pads useful in chemical mechanical polishing.

### BACKGROUND

Chemical Mechanical Planarization (CMP) is a variation of a polishing process that is widely used to flatten, or planarize, the layers of construction of an integrated circuit in order to precisely build multilayer-three-dimensional circuitry. The layer to be polished is typically a thin film (less than 10,000 Angstroms) that has been deposited on an underlying substrate. The objectives of CMP are to remove excess material on the wafer surface to produce an extremely flat layer of a uniform thickness, the uniformity extending across the entire wafer area. Control of removal rate and the uniformity of removal are of paramount importance.

CMP utilizes a liquid, often called slurry, which contains nano-sized particles. This is fed onto the surface of a rotating multilayer polymer sheet, or pad, which is mounted on a rotating platen. Wafers are mounted into a separate fixture, or carrier, which has a separate means of rotation, and pressed against the surface of the pad under a controlled load. This leads to a high rate of relative motion between the wafer and the polishing pad (i.e., there is a high rate of shear at both the substrate and the pad surface. Slurry particles trapped at the pad/wafer junction abrade the wafer surface, leading to removal. In order to control rate, prevent hydroplaning, and to efficiently convey slurry under the wafer, various types of texture are incorporated into the upper surface of the polishing pad. Fine scale texture is produced by abrading the pad with an array of fine diamonds. This is done to control and increase removal rate; and is commonly referred to as conditioning. Larger scale grooves of various patterns and dimensions (e.g., XY, circular, radial) are also incorporated for hydrodynamic and slurry transport regulation.

Removal rate during CMP is widely observed to follow the Preston Equation, Rate=Kp*P*V, where P is pressure of pad on substrate, V is velocity of pad relative to substrate, and Kp is the so-called Preston Coefficient. The Preston Coefficient is a lumped sum constant that is characteristic of the consumable set being used. Several of the most important effects contributing to Kp are as follows: (a) pad contact area (largely derived from pad texture and surface mechanical properties); (b) the concentration of slurry particles on the contact area surface available to do work; and (c) the reaction rate between the surface particles and the surface of the layer to be polished. Effect (a) is largely determined by pad properties and the conditioning process. Effect (b) is determined by both pad and slurry, while effect (c) is largely determined by slurry properties.

In addition to removal rate, defects formed in the substrate being polished can be problematic. For example, high abrasive slurries and/or hard pads or pads including hard particles can cause scratching in the substrate being polished. While a softer pad can reduce defects, such a pad can also have reduced removal rate. Since a hard or stiff pad can lead to higher removal rates but also high defect rates, it can be challenging to achieve a balance of both high removal rate and low rate of defects.

An improved pad could provide a balance of high removal rate and low defect rate that could be used optionally at higher pressures, with ceria slurries, or both would constitute a significant improvement in CMP technology.

### SUMMARY OF THE INVENTION

Disclosed herein is a polishing pad suitable for polishing at least one of semiconductor, optical, magnetic or electromechanical substrates comprising: a polishing layer including at least a three-part copolymer, the three-part copolymer including silicone, polyurea and polyurethane groups wherein the three-part copolymer has phase separated silicone-rich domains surrounded by low-silicon regions wherein the silicon-rich domains comprise silicone-based oligomeric repeat units that are covalently bonded to the polyurethane groups and the polyurethane groups are bonded to the polyurea groups.

Also disclosed herein is a method of use of the pad as disclosed herein in polishing. Polishing using such pad can achieve higher removal rate and/or lower defect than when polishing with a pad which is similar, but which lacks the phase separated silicon-rich domains.

### BRIEF DESCRIPTION OF THE DRAWINGS

Referring now to the figures, which are exemplary embodiments, and wherein the like elements are numbered alike.

FIG. 1 is a scanning electron microscopy (SEM) image at 500 times magnification of a portion of a polishing layer of a pad formed using a comparative composition.

FIG. 2 is a scanning electron microscopy (SEM) image at 500 times magnification of a portion of a polishing layer of a pad as disclosed herein.

FIG. 3 is a scanning electron microscopy (SEM) image at 500 times magnification of a portion of a polishing layer of a pad as disclosed herein.

FIG. 4 is a scanning electron microscopy (SEM) image at 500 times magnification of the top surface of a polishing layer of a pad as disclosed herein after polishing.

FIG. 5 is a scanning electron microscopy (SEM) image of a polymer useful in polishing layers as disclosed herein with a graphically represented result from an energy-dispersive x-ray spectroscopy (EDS) scan of the same sample taken along line a-a′.

FIG. 6 is a scanning electron microscopy (SEM) image with a corresponding image from an energy-dispersive x-ray spectroscopy (EDS) scan of the same sample.

### DETAILED DESCRIPTION

The polishing pad disclosed herein is suitable for polishing at least one of semiconductor, optical, magnetic or electromechanical substrates.

The pads can yield relatively high removal rate during polishing in combination with low defect rates. The pads can tolerate higher polishing pressures and polishing speeds. Furthermore, the polishing pad can achieve improved performance with a polishing pad that is hydrophilic during polishing. Achieving a hydrophilic polishing pad during polishing facilitates achieving a thin and efficient pad-wafer gap for efficient polishing.

Specifically, the pads as disclosed have a polishing layer that comprises a polyurethane-urea copolymer having repeat units from a silicone oligomer in addition to repeat units from polyols and isocyanate functional compounds. Specifically, the silicone oligomers are end capped with carbinol groups and reacted with the polyisocyanate functional compound to form the urethane-containing polyol prepolymer. This urethane-containing polyol prepolymer is reacted with an amine curing agent to form the urethane-urea copolymer. These pads surprisingly can provide both improved removal rate and reduced defects as compared to similar pads that lack the inclusion of the silicone oligomer repeat units in a urethane-urea copolymer.

The polyurethane can phase separate forming silicone-rich domains comprising higher concentrations of the silicone oligomer-based repeat units surrounded by domains comprising the polyurethane with lower concentrations of the silicone oligomer based repeat units. The polishing layer includes at least a three-part copolymer. Advantageously, the three-part copolymer includes silicone, polyurea and polyurethane groups. The three-part copolymer has phase separated silicone-rich domains surrounded by low-silicone-based oligomeric repeat units that are covalently bonded to the polyurethane groups and the polyurethane groups are bonded to the polyurea groups.

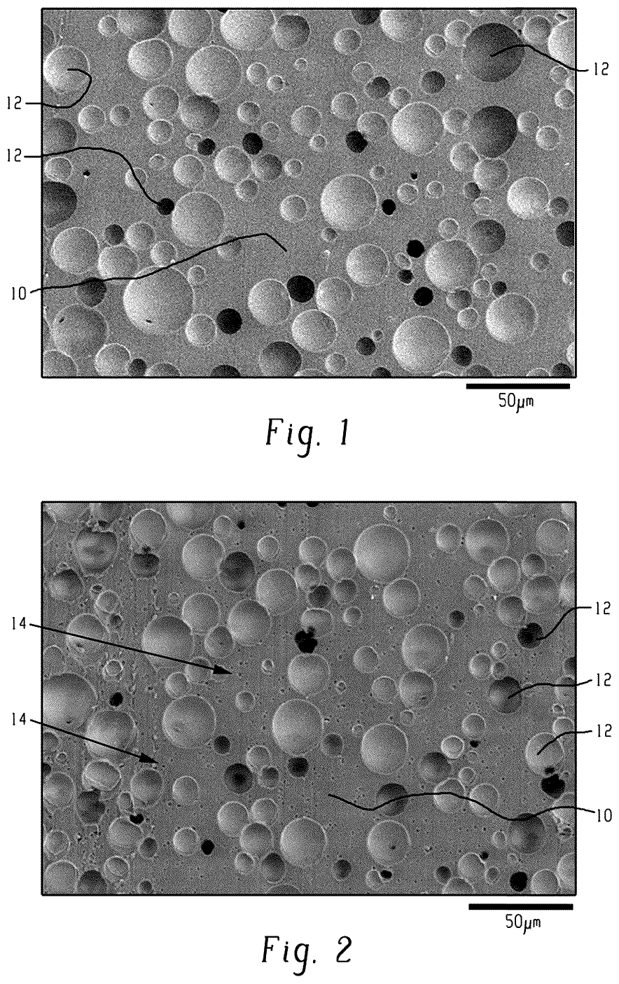

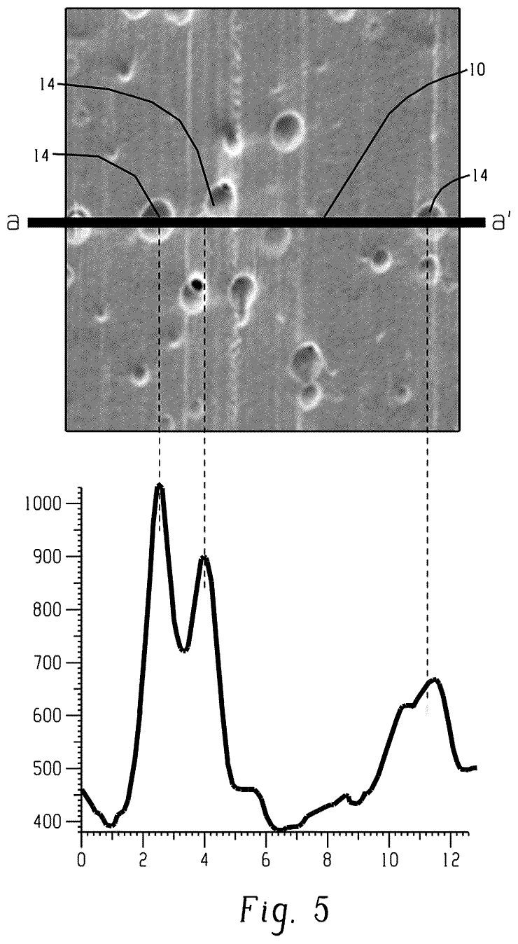

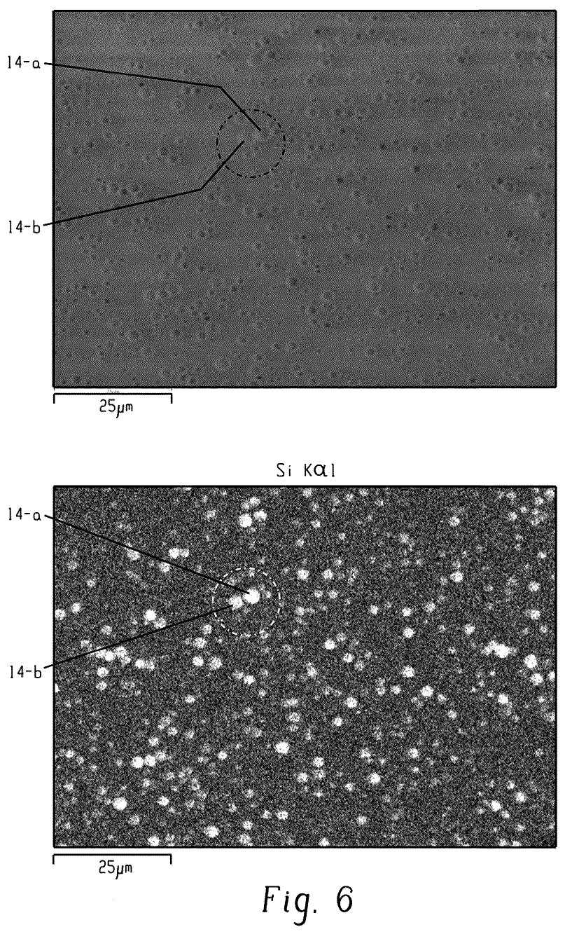

After phase separation, the silicone-rich domains can have more than 1.5 or more than 2 times the concentration of elemental silicon as found in low-silicone phase polyurethane surrounding the silicone-rich domains, as determined by energy-dispersive x-ray spectroscopy (EDS). The low-silicone regions represent a continuous two-phase mixture of soft and hard segments. For example, as shown in the scanning electron microscopy (SEM) photographs in FIGS. 2, 3, 4, 5 and 6, silicone-rich phase separated domains 14 can be seen within low-silicone polyurethane domain 10. In FIG. 5, the cured polymer having phase separated silicone-rich domains 14 is shown in the upper SEM photograph, while the underlying chart is an EDS result from a scan from a-a′. This shows that where the domains are found there is more elemental silicon. The high amounts of elemental silicon in the silicone-rich phase separated domain 14 is indicative of a concentration of silicone oligomer (e.g., oligomer comprising —[—(Si(R′)₂—O—]ₙ-repeat units) in the silicone-rich domain. Similarly, in FIG. 6, the upper SEM photograph shows the phase separated domains, such as 14-a and 14-b, while the lower EDS scan shows that such domains 14-a and 14-b are much brighter indicating a high concentration of elemental silicon in those domains. Because the silicone oligomer-based repeat units are covalently bonded in the polyurethane, the silicone-rich phase separated domains comprising high amounts of the silicone oligomer-based repeat units as a major component remain at the surface during and after conditioning and polishing. This is postulated to facilitate the benefit of improved removal rate together with reduced polishing defects seen in pads that incorporate the silicone oligomer-based repeat units as part of the polyurethane in the polishing layer. The size of the silicone-rich phase separated domains can be from 0.1, from 0.5, or from 1 up to 10, up to 9, up to 8, up to 7, up to 6, or up to 4 micrometers as determined by examination of SEM photos of the sample pad.

The polyurethane-polyurea copolymer can be formed by reaction of a prepolymer with an amine curing agent.

The prepolymer is the reaction product of one or more polyols, a silicone containing oligomer, and a polyisocyanate.

The polyols can be for example, polyether polyols (e.g., polyakylene glycols where the alkylene comprises 2 to 5 carbon atoms, such as poly(oxytetramethylene) glycol, poly(oxypropylene) glycol, polyoxyethylene) glycol); polycarbonate polyols; polyester polyols; polycaprolactone polyols; mixtures thereof; mixtures of one or more thereof with one or more low molecular weight polyols selected from the group consisting of ethylene glycol; 1,2-propylene glycol; 1,3-propylene glycol; 1,2-butanediol; 1,3-butanediol; 2-methyl 1,3-propanediol; 1,4-butanediol; neopentyl glycol; 1,5-pentanediol; 3-methyl-1,5-pentanediol; 1,6-hexanediol; diethylene glycol; dipropylene glycol; and, tripropylene glycol. The prepolymer polyol can be (PTMEG); polypropylene ether glycols (PPG), polyethylene ether glycols (PEG); or mixtures thereof optionally, mixed with one or more low molecular weight polyol selected such as ethylene glycol; 1,2-propylene glycol; 1,3-propylene glycol; 1,2-butanediol; 1,3-butanediol; 2-methyl-1,3-propanediol; 1,4-butanediol; neopentyl glycol; 1,5-pentanediol; 3-methyl-1,5-pentanediol; 1,6-hexanediol; diethylene glycol; dipropylene glycol; and tripropylene glycol. The polyol can be primarily (e.g., >90 wt %) polytetramethylene ether glycol.

The repeat units derived from these polyols (e.g., polyether polyols) can comprise from 45 wt % to 65 wt % of the prepolymer.

The silicone-containing oligomer can have silicone (i.e. —Si(R′)₂—O—) repeat units and reactive carbinol end cap groups that enable reaction with the other components to form the prepolymer. For example, the end cap groups can be polyether carbinol groups. For example, the silicone-containing oligomer can have the formula as follows:

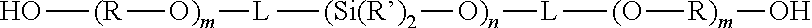

where R is an alkylene group, preferably of 3-5 carbon atoms, more preferably 3 carbon atoms, L is a bond or a divalent linking group, preferably comprising an alkylene group of 1 to 5 carbon atoms, a substituted or unsubstituted Si atom or both, R′ is independently in each occurrence H or an alkyl group of 1, 2 or 3 carbon atoms, preferably R′ is a methyl group. “m” is an integer of at least 5, at least 10 or at least 12 up to 20, up to 18 or up to 16. “n” is an integer of at least 5, at least 10, or at least 12, up to 20, up to 18, or up to 16. The amount of the silicone-containing oligomer in the prepolymer can be from 6, from 7, from 8, from 9, from 10 up to 20 weight % based on total weight of the prepolymer.

The isocyanate is polyfunctional, for example, a diisocyanate. Examples of diisocyanates include 2,4-toluene diisocyanate; 2,6-toluene diisocyanate; 4,4′ diphenylmethane diisocyanate; 4,4′-Methylenebis(cyclohexyl isocyanate) (H₁₂MDI); naphthalene-1,5-diisocyanate; toluidine diisocyanate; para-phenylene diisocyanate; xylylene diisocyanate; isophorone diisocyanate; hexamethylene diisocyanate; cyclohexanediisocyanate; and mixtures thereof. The diisocyanate can be, for example, a mixture of toluene diisocyanate and H₁₂MDI in weight ratios of 10:90 to 95:5, or 50:50 to 90:10, or 70:30 to 85:15.

The prepolymer can have an unreacted isocyanate (NCO) concentration of from 7.5% up to 9.5, up to 9, or up to 8.5 wt %. The amount of polyisocyanate reacted with the polyols and the silicone oligomer is selected to achieve the desired amount of unreacted isocyanate.

The prepolymer can be a low free isocyanate terminated urethane prepolymer having less than 0.1 wt % free toluene diisocyanate (TDI) monomer content.

The curative agent can be Bis(4-amino-2-chloro-3,5-diethylphenyl)methane (“MCDEA”), diethyltoluenediamine (DETDA); 3,5-dimethylthio-2,4-toluenediamine and isomers thereof; 3,5-diethyltoluene-2,4-diamine and isomers thereof (e.g., 3,5-diethyltoluene-2,6-diamine); 4,4′-bis-(sec-butylamino) diphenylmethane; 1,4-bis-(sec-butylamino)-benzene, 4,4′-methylene-bis-(2-chloroaniline) polytetramethyleneoxide-di-p-aminobenzoate; N,N-dialkyl diamino diphenyl methane; p,p′-methylene dianiline (MDA); m-phenylenediamine (MPDA); 4,4′-methylene-bis(2-chloroaniline) (MBOCA); 4,4′-methylene-bis-(2,6-diethylaniline) (MDEA); 4,4′-methylene-bis-(2,3-dichloroaniline) (MDCA); 4,4′-diamino-3,3′-diethyl-5,5′-dimethyl diphenylmethane, 2,2′,3,3-tetrachloro diamino diphenyl methane; trim ethylene glycol di-p-aminobenzoate; and mixtures thereof. The curative can be used in an amount such that the ratio of reactive groups on the curative (e.g. amine groups) that are available to react with the isocyanate groups of the prepolymer is from 0.87:1 to 1.05:1.

The polishing layer of the chemical mechanical polishing pad disclosed herein can further contain a plurality of microelements. The microelements can be uniformly dispersed throughout the polishing layer or can be dispersed according to a gradient from top to bottom of the polishing layer. The microelements can be, for example, entrapped gas bubbles, hollow core polymeric materials, liquid filled hollow core polymeric materials, water soluble materials and an insoluble phase material (e.g., mineral oil). More particularly, the plurality of microelements can be selected from entrapped gas bubbles and hollow core polymeric materials uniformly distributed throughout the polishing layer. The plurality of microelements can have a weight average diameter of less than 150 μm, or equal to or less than 50 μm; and at least 1 or at least 10 μm. For example, the plurality of microelements can be polymeric microballoons with shell walls of either polyacrylonitrile or a vinylidene chloride-polyacrylonitrile copolymer (such as, e.g., Expancel™ microspheres from Akzo Nobel). The plurality of microelements that provide porosity can be incorporated into the polishing layer to yield from 0 to 50 volume % porosity or 10 to 35 volume % porosity. The volume % of porosity can be determined by dividing the difference between the specific gravity of an unfilled polishing layer and specific gravity of the microelement containing polishing layer by the specific gravity of the unfilled polishing layer.

The polishing layer of the polishing pad disclosed herein can be provided in porous or nonporous (i.e., unfilled) configurations. The polishing layer of the chemical mechanical polishing pad disclosed herein can have a density of 0.4 to 1.15 g/cm³, or 0.70 to 1.0 g/cm³; as measured according to ASTM D1622 (2014).

The polishing pads disclosed herein can be made by methods comprising: providing the isocyanate terminated urethane prepolymer; providing separately the curative component; and combining the isocyanate terminated urethane prepolymer and the curative component to form a combination; allowing the combination to react to form a product; forming a polishing layer from the product, such as by skiving the product to form a polishing layer of a desired thickness and grooving the polishing layer, such as by machining it and forming the chemical mechanical polishing pad with the polishing layer.

The polishing layer of the chemical mechanical polishing pad disclosed herein can have a Shore D hardness of 28 to 75 as measured according to ASTM D2240 (2015).

The polishing layer can have an average thickness of 20 to 150 mils (0.05 to 0.4 cm), 30 to 125 mils (0.08 to 0.3 cm, 40 to 120 mils (0.1 to 0.3 cm), or 50 to 100 mils (0.13 to 0.25 cm).

The polishing pad disclosed herein can be adapted to be interfaced with a platen of a polishing machine. For example, the CMP polishing pad can be adapted to be affixed (e.g., using at least one of a pressure sensitive adhesive or vacuum) to the platen of a polishing machine.

The polishing pad disclosed herein optionally further comprises at least one additional layer interfaced with the polishing layer. For example, the CMP polishing pad optionally can further comprise a compressible base layer adhered to the polishing layer. The compressible base layer can improve conformance of the polishing layer to the surface of the substrate being polished.

The polishing pad disclosed herein in its final form can further include texture in one or more dimensions on its upper surface. Such texture may be classified by their size into macrotexture or microtexture. Macrotexture can facilitate control of hydrodynamic response and slurry transport. Macrotexture can include, without limitation, grooves of many configurations and designs, such as annular, radial, biased radial and cross-hatchings, protrusions (e.g., columns, pyramids of varying shape) arranged in regular or occurrence or annular or radial pattern, or the like. These may be formed directly on the pad by molding or by machining processes on a thin uniform sheet. Microtexture comprises finer scale features that create a population of surface asperities that are the points of contact with the substrate wafer where polishing occurs. For example, microtexture can include, without limitation, texture formed by abrasion with an array of hard particles, such as diamond (often referred to as pad conditioning), either prior to, during or after use, and microtexture formed during the pad fabrication process.

CMP polishing pads are used in conjunction with a polishing slurry, as described in the Background herein. The polishing pads disclosed herein can particularly be used with such slurries and particularly with slurries whose pH is below the isoelectric point pH of the particle being used. For example, ceria has an isoelectric pH of approximately 6.6. Below this pH, the particle surface has a net positive charge. Above this pH, the particle has a net negative charge. Since pads disclosed herein can exhibit a high negative charge at that pH, the rate enhancement is achieved when the particles are below the isoelectric point. In addition to the selection of slurry, additional polishing conditions can include polishing pressure, polishing speed, polishing time and polishing temperature.

The polishing pads disclosed herein may be manufactured by a variety of processes that are compatible with thermoset urethanes. These include mixing the ingredients as described above and casting into a mold, annealed, and sliced into sheets of the desired thickness. Alternatively, they may be made in a more precise net shape form. For example, the following process can be used: 1. thermoset injection molding (often referred to as “reaction injection molding” or “RIM’); 2. thermoplastic or thermoset injection blow molding; 3. compression molding; or 4. any similar-type process in which a flowable material is positioned and solidified, thereby creating at least a portion of a pad's macrotexture or microtexture. In a molding example: 1. the flowable material is forced into or onto a structure or substrate; 2. the structure or substrate imparts a surface texture into the material as it solidifies, and 3. the structure or substrate is thereafter separated from the solidified material.

### EXAMPLES

### Synthesis of Prepolymers Procedure

Prepolymers were synthesized in ˜200-1000 g batches. All polyols (the polytetramethylene ether glycol (PTMEG) of various molecular weights and the silicone oligomer of the following formula

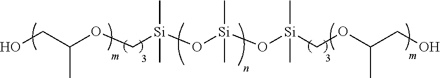

where m is 12-16 and n is selected such that the oligomer is 50 wt % of the non-siloxane components) were dried in a vacuum oven at 80° C. overnight before using. The polyol mixtures were added to mixing cups and mixed in a vortex mixer at 1000 RPM for 30 seconds. Toluene diisocyanate (TDI) and 4,4′-Methylenebis(cyclohexyl isocyanate) (H₁₂MDI) were mixed at 80:20 weight ratio before adding to polyol mixture in mixing cup. Enough isocyanate mixture was then added to the polyol mixture in mixing cup for the desired NCO wt %. The whole mixture was again mixed via a vortex mixer under the same conditions as before. The prepolymer mixture is then placed in a pre-heated oven at 65° C. for 4 hours before use.

The weight percent of components based on total weight of prepolymer that were used to synthesize the prepolymers are shown in Table 1.

TABLE 1
Prepolymer composition

| | Wt % | Wt % | Wt % | | | | |
|---|---|---|---|---|---|---|---|
| | PTMEG | PTMEG | PTMEG | Wt % | Wt % | Wt % | unreacted |
| | 250 of | 650 of | 1000 of | PTMEG | silicone | isocyanate | NCO % in |
| Prepolymer | polyol | polyol | polyol | 2000 | oligomer | mixture | prepolymer |
| 1 | 8.4 | 21.6 | 23.8 | 9.5 | 0 | 36.7 | 8.1 |
| (control) | | | | | | | |
| 2 | 8.2 | 21.2 | 23.2 | 4.6 | 6.6 | 36.1 | 8.0 |
| 3 | 8.0 | 20.8 | 22.8 | 0 | 13 | 35.3 | 7.8 |

### Production of Polishing Layer Material

Where porosity is desired, expandable polymeric microspheres were added to the prepolymers after the 4 hour reaction time or once heated and degassed with polymeric microspheres in prepolymer via vacuum. The samples used for polishing included a distribution of polymeric microspheres sufficient to reach either a specific gravity or final density. After degassing and once both components are at temperature, Ethacure™ 300 curing agent was added to the heated pre-polymer at an amount to have 87% stoichiometry (i.e., mole ratio of amine groups on the curing agent to NCO groups on the prepolymer is 0.87:1). After mixing, the sample was poured onto a heated plate and drawn using a Teflon™ polytetrafluoroethylene-coated bar with a spacer set at 175 mil (4.4 mm). The plate was then transferred into an oven and heated to 104° C. and held at temperature for 16 hours. The drawdown was then demolded.

### Production of Pad

All pads were 30″ (76 cm) in diameter with an 80 mil (2.0 mm) thickness top pad, 1010 circular grooving having a width, depth and pitch of 20 mils, 30 mils, and 120 mils (0.51 mm, 0.76 mm and 3.05 mm), respectively, pressure sensitive adhesive film for the subpad, Suba IV™ polyurethane impregnated polyester felt subpad, and pressure sensitive platen adhesive. Plaques of each material set were also made for property testing both with and without the polymeric microsphere filler.

### Example 1

The compositions of a polishing layer material that included expandable polymeric microspheres were prepared, sliced and then examined using scanning electron microscopy (SEM).

In FIG. 1, which shows a pad material made using prepolymer sample 1 (Control) that did not include a silicone-based oligomer the bulk polyurethane matrix 10 and the expanded polymeric microspheres 12 can be seen. No phase separation in the polyurethane matrix 10 was seen.

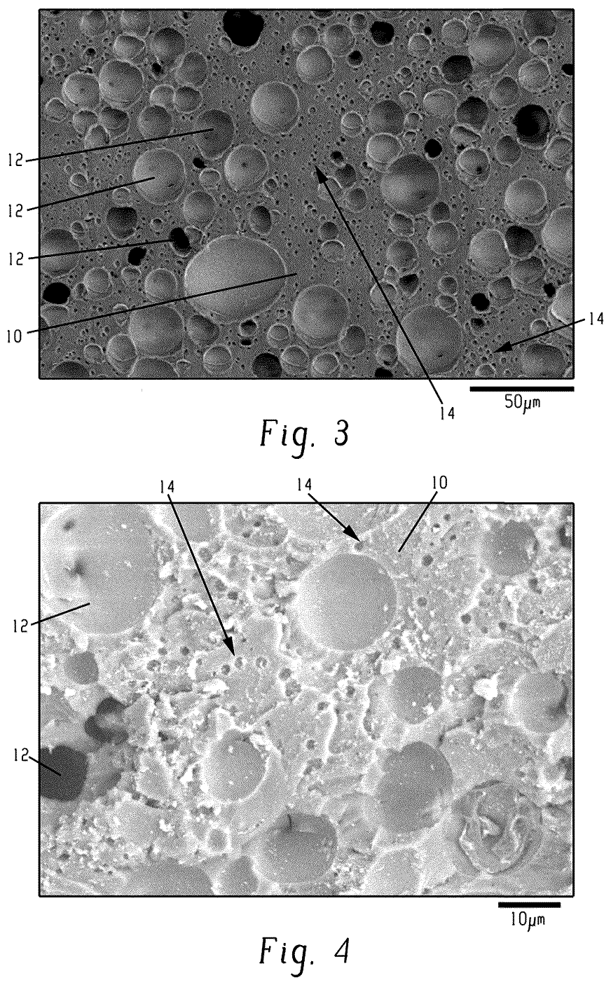

In contrast, in FIGS. 2 and 3, showing pad materials made using prepolymer samples 2 and 3 respectively, in addition to a bulk polyurethane matrix 10 and the expanded polymeric microspheres, small phase separated domains 14 from the repeat units of the silicone-based oligomer were seen. Significantly more of the phased separated domains 14 were seen in FIG. 3 that had twice as much of the silicone oligomer based repeat units in the polymer.

### Example 2

Pads made using the formulations of samples 1 (control), 2 and 3 were conditioned and used for polishing. As shown in FIG. 4, an SEM of the top polishing surface of the pad made using sample 3 shows that the phase separated domains 14 from the repeat units of the silicone-based oligomer remain at the polishing surface after conditioning and polishing.

### Example 3

Pads were made as described above with expandable polymeric microspheres and Ethacure™ 300 curing agent using the prepolymer formulations of samples 1 (control), 2 and 3. These pads were conditioned and used for polishing of a silicon oxide substrate using a ceria-based slurry. The results are shown in Table 2. The 100 in-situ testing is where there was 100% continuous conditioning during polishing. The 20 in-situ is where the pad was conditioned only during 20% of the polishing time. Surprisingly, the use of the silicone based oligomer in forming the prepolymer both increased removal rate and decreased defects.

### Table 2

TABLE 2

| | Average | Average | | |
|---|---|---|---|---|
| | Removal Rate | Removal Rate | | |
| | (Angstroms/ | (Angstroms/ | Subtractive | Subtractive |
| | minute) | minute) | Defects | Defects |
| Sample | (100 in-situ) | (20 in-situ) | (100 in-situ) | (20 in-situ) |
| 1 | 2297 | 2589 | 11 | 15 |
| (Control) | | | | |
| 2 | 2856 | 3405 | 8 | 4 |
| 3 | 2539 | 3657 | 6 | 2 |

Subtractive = Any damage to the film surface that has the potential to cause electrical or other damage to future layers in a chip building/stacking manufacturing process. These are often referred to as: Scratch, Chattermark, Divots, rice marks (customer term).
(XXX in-situ) = Percent of polishing time where in-situ diamond disk conditioning occurred.

### Example 4

Polishing material was prepared using prepolymer 2 substantially as above except no expandable polymeric microspheres were used and the Ethacure™ 300 curing agent was added to the heated pre-polymer at an amount to have 105% stoichiometry (i.e., mole ratio of amine groups on the curing agent to NCO groups on the prepolymer is 1.05:1). The polishing material was examined by SEM as shown in the SEM photograph in FIG. 5 and then the polishing material was examined by EDS along the line from a-a′ and the results showing amount of elemental silicon detected by EDS along that scan line is shown in the graph. As can be seen the amount of elemental silicon was higher in the areas of the silicone-rich phase separated domains 14 than in the surrounding polyurethane 10.

### Example 5

Polishing material was prepared using prepolymer 2 substantially as above except no expandable polymeric microspheres were used. This polishing material was examined by SEM and EDS. FIG. 6 shows the SEM photograph and EDS scan results of the same sample. The silicone-rich areas are the bright spots on the EDS scan that corresponded to the phase separated domains, such as 14-a and 14-b.

After soaking the samples in water for 7 days, it was observed that the wet hardness decreased more with increasing content of the PPG end-capped silicone diol as shown in Table 3 below.

Table 3. Hardness change after 7 day soak in water.

TABLE 3
Hardness (Shore D) change after 7 day soak in water

| | | | | | | Hardness | Hardness |
|---|---|---|---|---|---|---|---|
| | Water | Hardness | Hardness | Hardness | Hardness | difference | difference |
| | Uptake | 2 sec | 15 sec | 2 sec | 15 sec | 2 sec dry | 15 sec dry |
| Sample | (wt %) | Dry | Dry | Wet | Wet | vs. wet | vs. wet |
| 1 | 1.85 | 64.3 | 61.2 | 59.1 | 55.4 | −8.1% | −9.5% |
| (Control) | | | | | | | |
| 2 | 1.86 | 64.4 | 61.3 | 59.9 | 55.9 | −7.0% | −8.8% |
| 3 | 1.90 | 63.4 | 59.7 | 57.3 | 52.5 | −9.6% | −12.0% |

The increased softening occurred despite the percent water uptake being similar for all samples. As PPG can increase water uptake and lead to softening in comparison to all PTMEG base prepolymers, and the PPG was associated with the silicone diol, this change appears to be the result of preferential water absorption by the silicone-rich phase separated domains. The preferential water uptake was also consistent with the intermediate silicone content only having minimal effect as the softening was not sufficient to alter the bulk measurement. This provides an unexpected benefit of more than offsetting wettability issues with the incorporation of silicone hydrophobic units into a CMP pad. For example, limited wetting of slurry on the polishing pad can reduce polishing performance, such as rate and global uniformity.

Upon conditioning it is observed that these domains were present at the surface and found on the land area between the pores as shown in FIG. 3 and increase in number and size with silicone diol content. As they were covalently bond to the material, they are not removed by conditioning like would be the case in a composite approach.

This disclosure further encompasses the following aspects.

Aspect 1: A Disclosed herein is a polishing pad suitable for polishing at least one of semiconductor, optical, magnetic or electromechanical substrates comprising: a polishing layer including at least a three-part copolymer, the three-part copolymer including silicone, polyurea and polyurethane groups wherein the three-part copolymer has phase separated silicone-rich domains surrounded by low-silicon regions wherein the silicon-rich domains comprise silicone-based oligomeric repeat units that are covalently bonded to the polyurethane groups and the polyurethane groups are bonded to the polyurea groups.

Aspect 2. The polishing pad of Aspect 1 wherein the phase separated silicon-rich domains have an average size of 0.1 to 10, preferably 0.5 to 8, more preferably 1 to 6 micrometers.

Aspect 3. The polishing pad of Aspect 1 or 2 wherein the silicon-rich domains comprise at least 1.5, preferably at least 2 times the amount of elemental silicon found in the low-silicone regions surrounding the silicon-rich domains.

Aspect 4. The polishing pad of any one of the previous Aspects wherein the polishing layer is porous.

Aspect 5. The polishing pad any one of the previous Aspects wherein the polishing layer comprises expandable or expanded polymeric microspheres.

Aspect 6. The polishing pad of Aspect 6 wherein the low-silicone regions represent a continuous two-phase mixture of soft and hard segments.

Aspect 7. The polishing pad of Aspect 1 wherein silicone is from a silicone-containing oligomer having a formula as follows:

HO—(R—O)ₘL-(Si(R′)₂—O)ₙ-L-(O—R)ₘ—OH

where R is an alkylene group, L is a bond or a divalent linking group, a substituted or unsubstituted Si atom or both, R′ is independently in each occurrence H or an alkyl group of 1, 2 or 3 carbon atoms and “m” is an integer of at least 5 and “n” is an integer of at least 5.

Aspect 8. The polishing pad of Aspect 7 wherein R has 3-5 carbon atoms, L is an alkylene group of 1 to 5 carbon atoms, a substituted or unsubstituted Si atom or both, “m” is an integer of at least 10 and “n” is an integer of at least 10.

Aspect 9. The polishing pad of Aspect 7 or 8 wherein R is an alkylene group of 3 carbon atoms.

Aspect 10. The polishing pad of Aspect 1 wherein polypropylene ether glycol is associated with a silicone diol of the silicone-based oligomer.

Aspect 11. A method of polishing a substrate comprising providing the polishing pad of any one of Aspects 1 to 5 and a slurry and polishing the substrate.

Aspect 12. The method of Aspect 6 wherein a removal rate of the substrate is higher than a removal rate for polishing using a pad of the same composition and density except lacking the phase separated silicon-rich domains.

Aspect 13. The method of claim 6 or 7 wherein a defect rate from polishing is less than for polishing using a pad of the same composition and density except lacking the phase separated silicon-rich domains.

Aspect 14. The method of any one of Aspects 6 to 8 wherein a portion of the phase-separated silicon-rich domains are present at the polishing surface after conditioning, after polishing or both.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). Moreover, stated upper and lower limits can be combined to form ranges (e.g. “at least 1 or at least 2 weight percent” and “up to 10 or 5 weight percent” can be combined as the ranges “1 to 10 weight percent”, or “1 to 5 weight percent” or “2 to 10 weight percent” or “2 to 5 weight percent”).

The disclosure may alternately comprise, consist of, or consist essentially of, any appropriate components herein disclosed. The disclosure may additionally, or alternatively, be formulated so as to be devoid, or substantially free, of any components, materials, ingredients, adjuvants or species used in the prior art compositions or that are otherwise not necessary to the achievement of the function and/or objectives of the present disclosure.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

Unless specified to the contrary herein, all test standards are the most recent standard in effect as of the filing date of this application, or, if priority is claimed, the filing date of the earliest priority application in which the test standard appears.

What is claimed is:

1. A polishing pad suitable for polishing at least one of semiconductor, optical, magnetic or electromechanical substrates comprising:
a polishing layer including at least a three-part copolymer, the three-part copolymer including silicone, polyurea and polyurethane groups wherein the three-part copolymer has phase separated silicone-rich domains surrounded by low-silicone regions wherein the silicon-rich domains comprise silicone-based oligomeric repeat units that are covalently bonded to the polyurethane groups and the polyurethane groups are bonded to the polyurea groups.

2. The polishing pad of claim 1 wherein the phase separated silicon-rich domains have an average size of 0.1 to 10 micrometers.

3. The polishing pad of claim 1 wherein the silicon-rich domains comprise at least 1.5 times the amount of elemental silicon found in the low-silicone regions surrounding those silicon-rich domains.

4. The polishing pad of claim 1 wherein the polishing layer is porous.

5. The polishing pad of claim 1 wherein the polishing layer comprises expandable or expanded polymeric microspheres.

6. The polishing pad of claim 1 wherein the low-silicone regions represent a continuous two-phase mixture of soft and hard segments.

7. The polishing pad of claim 1 wherein silicone is from a silicone-containing oligomer having a formula as follows:
HO—(R—O)ₘL-(Si(R′)₂O)ₙ-L-(O—R)ₘ—OH
where R is an alkylene group, L is a bond or a divalent linking group, a substituted or unsubstituted Si atom or both, R′ is independently in each occurrence H or an alkyl group of 1, 2 or 3 carbon atoms and “m” is an integer of at least 5 and “n” is an integer of at least 5.

8. The polishing pad of claim 7 wherein R has 3-5 carbon atoms, L is an alkylene group of 1 to 5 carbon atoms, a substituted or unsubstituted Si atom or both, “m” is an integer of at least 10 and “n” is an integer of at least 10.

9. The polishing pad of claim 7 wherein R is an alkylene group of 3 carbon atoms.

10. The polishing pad of claim 1 wherein polypropylene ether glycol is associated with a silicone diol of the silicone-based oligomer.
